(19) United States
(12) Patent Application Publication
(10) Pub. No.: US 2026/0245793 A1
(43) Pub. Date: Aug. 20, 2026

(54) MULTILAYER CERAMIC CAPACITOR

(71) Applicant: Murata Manufacturing Co., Ltd., Nagaokakyo-shi (JP)

(72) Inventors: Hiroyuki ABE, Nagaokakyo-shi (JP); So FUJIYOSHI, Nagaokakyo-shi (JP); Fumiya ITO, Nagaokakyo-shi (JP); Kanta MATSUO, Nagaokakyo-shi (JP)

(73) Assignee: Murata Manufacturing Co., Ltd., Nagaokakyo-shi (JP)

(21) Appl. No.: 19/531,802

(22) Filed: Feb. 6, 2026

(30) Foreign Application Priority Data
Feb. 14, 2025 (JP) 2025-022217

(51) Int. Cl. H01G 4/005; H01G 4/12; H01G 4/232; H01G 4/248; H01G 4/30

(52) U.S. Cl. CPC H01G 4/005; H01G 4/232; H01G 4/248; H01G 4/30; H01G 4/12

(57) ABSTRACT

A multilayer ceramic capacitor includes a base body and outer electrodes. The base body includes a plurality of dielectric layers and a plurality of inner electrode layers laminated in a lamination direction between first and second principal surfaces. In a cross-section taken in the lamination width directions, the inner electrode layers includes a first set of layers having end portions curved toward the second principal surface and a second set of layers curved toward the first principal surface. The second set of layers are nearer to the second principal surface than the first set of layers. A number of layers of the second set is greater than a number of layers of the first set.

### CROSS-REFERENCE TO RELATED APPLICATION

This application is based upon and claims the benefit of priority from Japanese Patent Application No. 2025-022217, filed Feb. 14, 2025, the entire contents of which are incorporated herein by reference.

### BACKGROUND

### 1. Field

The present disclosure relates to a multilayer ceramic capacitor.

### 2. Description of the Related Art

In the related art, a multilayer ceramic capacitor including a base body and outer electrodes is known. The base body has a substantially rectangular parallelepiped shape and is composed of a plurality of dielectric layers and a plurality of inner electrode layers alternately laminated. The outer electrodes are provided to a pair of end surfaces in the longitudinal direction of the base body.

In general, the plurality of inner electrode layers are formed by layering mother sheets having inner electrode patterns. During this process, opposite end portions in the width direction of some of the inner electrode layers may be caused to curve toward the central portion in the lamination direction, due to the self-weight of the above-mentioned inner electrode layers and the load of layers disposed on the above-mentioned inner electrode layers. An example of the above-described multilayer ceramic capacitor is disclosed in, for example, Japanese Unexamined Patent Application Publication No. 2021-19186.

### SUMMARY

The multilayer ceramic capacitor according to the present disclosure includes a base body and outer electrodes. The base body includes a plurality of dielectric layers and a plurality of inner electrode layers laminated in a lamination direction, and has a first principal surface and a second principal surface disposed opposite to each other in the lamination direction, a first side surface and a second side surface disposed opposite to each other in a width direction orthogonal to the lamination direction, and a first end surface and a second end surface disposed opposite to each other in a longitudinal direction orthogonal to the lamination direction and the width direction. The outer electrodes are respectively provided to the first end surface and the second end surface and are connected to the plurality of inner electrode layers. In a cross section of the base body taken in the lamination direction and the width direction in a central portion in the longitudinal direction, the plurality of inner electrode layers have a plurality of first inner electrode layers having opposite end portions in the width direction curved toward the second principal surface and a plurality of second inner electrode layers having opposite end portions in the width direction curved toward the first principal surface. The plurality of second inner electrode layers are disposed nearer to the second principal surface than the plurality of first inner electrode layers. The plurality of second inner electrode layers are greater in number than the plurality of first inner electrode layers.

In the multilayer ceramic capacitor according to the present disclosure, the plurality of dielectric layers may each have a thickness dimension of 0.4 μm or more and 6.2 μm or less.

In the multilayer ceramic capacitor according to the present disclosure, in the cross section of the base body, a curvature of the opposite end portions in the width direction of the first inner electrode layer nearest to the first principal surface among the plurality of first inner electrode layers may be greater than a curvature of the opposite end portions in the width direction of the second inner electrode layer nearest to the second principal surface among the plurality of second inner electrode layers.

In the multilayer ceramic capacitor according to the present disclosure, in the cross section of the base body, the plurality of inner electrode layers may further include a plurality of third inner electrode layers positioned between the plurality of first inner electrode layers and the plurality of second inner electrode layers in the lamination direction. In that case, in the cross section of the base body, the plurality of third inner electrode layers may extend substantially linearly along the width direction.

In the multilayer ceramic capacitor according to the present disclosure, the plurality of third inner electrode layers may be smaller in number than the plurality of first inner electrode layers.

In the multilayer ceramic capacitor according to the present disclosure, the base body may have a first ridge defined by an intersection between the first side surface and the first principal surface and a second ridge defined by an intersection between the first side surface and the second principal surface. In that case, in the cross section of the base body, a curvature of the first ridge may be smaller than a curvature of the second ridge.

### BRIEF DESCRIPTION OF THE DRAWINGS

FIG. 1 is a perspective view schematically illustrating an external appearance of a multilayer ceramic capacitor according to an embodiment;

FIG. 2 is a schematic cross-sectional view taken along line II-II shown in FIG. 1;

FIG. 3 is a schematic cross-sectional view taken along line III-III shown in FIG. 1;

FIG. 4 is a schematic cross-sectional view taken along line IV-IV shown in FIG. 2 as seen in the direction of the arrows;

FIG. 5 is a schematic cross-sectional view taken along line V-V shown in FIG. 2 as seen in the direction of the arrows;

FIG. 6 is a schematic cross-sectional view of inner electrode layers extracted from FIG. 3; and

FIG. 7 is a flowchart showing a method of producing the multilayer ceramic capacitor according to the embodiment.

### DESCRIPTION OF THE EMBODIMENTS

An embodiment of the present disclosure will be described in detail below with reference to the drawings. Note that, in the following embodiment, the same or common parts are denoted by the same reference numerals in the drawings, and the description thereof will not be repeated.

Note that, in the drawings, the longitudinal direction, the width direction, and the lamination direction of a base body of a multilayer ceramic capacitor are denoted by L, W, and T, respectively. Detailed description of the base body will be given later.

In the case where the inner electrode layers are curved as described in the related art, there is an increased risk of structural defects caused by contact between the inner electrodes neighboring in the lamination direction. The structural defects described above may cause a short circuit, which may lead to a decrease in reliability of the multilayer ceramic capacitor.

Accordingly, the present disclosure has been made to solve the above-described problem, and is directed to providing a multilayer ceramic capacitor in which the occurrence of structural defects is reduced.

### Embodiment

### A. Configuration of Multilayer Ceramic Capacitor

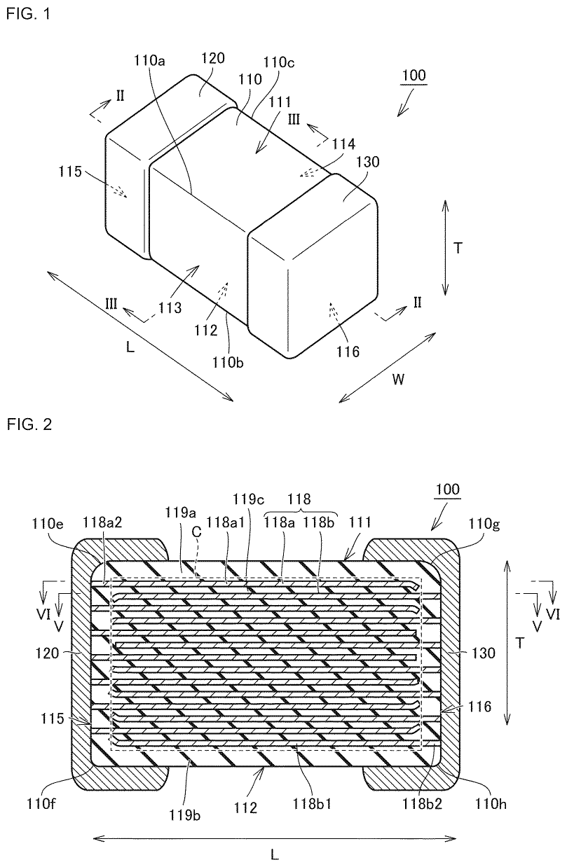

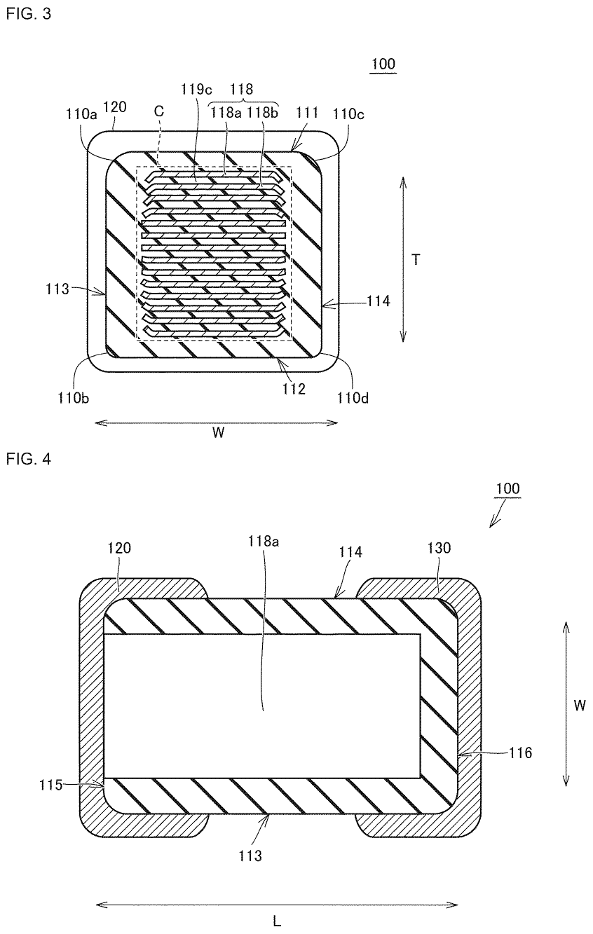

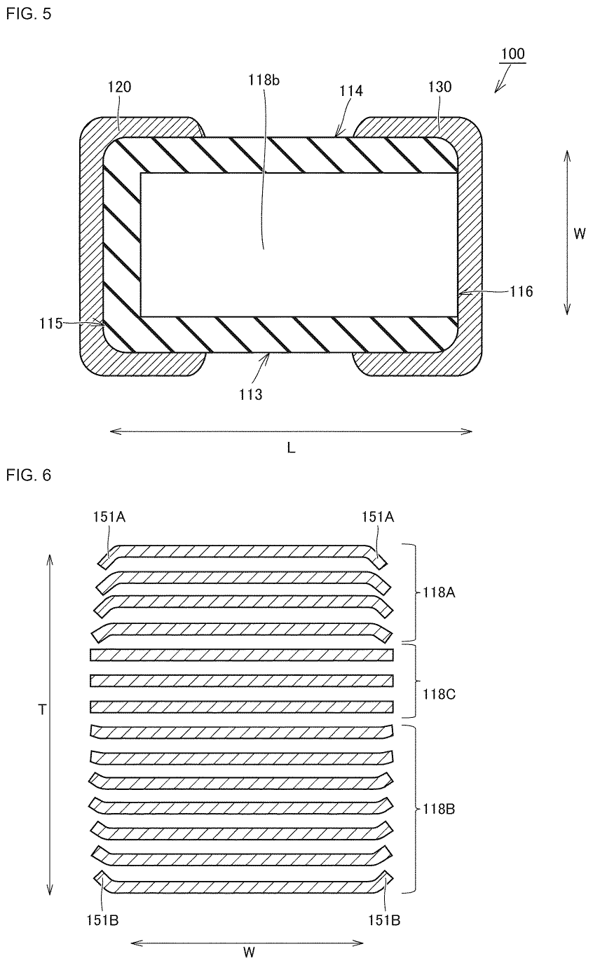

FIG. 1 is a perspective view schematically illustrating an external appearance of the multilayer ceramic capacitor according to the embodiment. FIG. 2 is a schematic cross-sectional view taken along line II-II shown in FIG. 1. Specifically, FIG. 2 is a schematic view of a cross section of the base body taken in the lamination direction T and the longitudinal direction L in the central portion in the width direction W. In the following, the cross section is also referred to as a cross section Q for the convenience of description. FIG. 3 is a schematic cross-sectional view taken along line III-III shown in FIG. 1. Specifically, FIG. 3 is a schematic view of a cross section of the base body taken in the lamination direction T and the width direction W in the central portion in the longitudinal direction L. In the following, the cross section is also referred to as a cross section P for the convenience of description. FIG. 4 is a schematic cross-sectional view taken along line IV-IV shown in FIG. 2. FIG. 5 is a schematic cross-sectional view taken along line V-V shown in FIG. 2. FIG. 6 is a schematic cross-sectional view of inner electrode layers extracted from FIG. 3. First, the configuration of a multilayer ceramic capacitor 100 according to the present embodiment will be described with reference to FIGS. 1 to 6.

As illustrated in FIGS. 1 to 6, the multilayer ceramic capacitor 100 according to the present embodiment includes a base body 110 and outer electrodes. The outer electrodes are composed of a first outer electrode 120 and a second outer electrode 130.

The base body 110 has a substantially rectangular parallelepiped shape. The base body 110 has a first principal surface 111 and a second principal surface 112 disposed opposite to each other in the lamination direction T, a first side surface 113 and a second side surface 114 disposed opposite to each other in the width direction W orthogonal to the lamination direction T, and a first end surface 115 and a second end surface 116 disposed opposite to each other in the longitudinal direction L orthogonal to the lamination direction T and the width direction W.

The base body 110 has a first ridge 110a, a second ridge 110b, a third ridge 110c, and a fourth ridge 110d. The first ridge 110a is defined by an intersection between the first side surface 113 and the first principal surface 111. The second ridge 110b is defined by an intersection between the first side surface 113 and the second principal surface 112. The third ridge 110c is defined by an intersection between the second side surface 114 and the first principal surface 111. The fourth ridge 110d is defined by an intersection between the second side surface 114 and the second principal surface 112.

Each of the first ridge 110a, the second ridge 110b, the third ridge 110c, and the fourth ridge 110d may be rounded. As seen in the cross section P of the base body 110 (see FIG. 3), the curvature of the first ridge 110a may be smaller than the curvature of the second ridge 110b. The curvature of the third ridge 110c may be smaller than the curvature of the fourth ridge 110d. The curvature of the first ridge 110a and the curvature of the third ridge 110c may be substantially the same. The curvature of the second ridge 110b and the curvature of the fourth ridge 110d may be substantially the same. These differential curvatures of the ridges may serve as visual or measurable indicators of the internal layering orientation, allowing for non-destructive verification of the lamination direction T.

The base body 110 has an end-surface-side first ridge 110e, an end-surface-side second ridge 110f, an end-surface-side third ridge 110g, and an end-surface-side fourth ridge 110h. The end-surface-side first ridge 110e is defined by an intersection between the first end surface 115 and the first principal surface 111. The end-surface-side second ridge 110f is defined by an intersection between the first end surface 115 and the second principal surface 112. The end-surface-side third ridge 110g is defined by an intersection between the second end surface 116 and the first principal surface 111. The end-surface-side fourth ridge 110h is defined by an intersection between the second end surface 116 and the second principal surface 112.

Each of the end-surface-side first ridge 110e, the end-surface-side second ridge 110f, the end-surface-side third ridge 110g, and the end-surface-side fourth ridge 110h is rounded. As seen in the cross section Q of the base body 110 (see FIG. 2), the curvature of the end-surface-side first ridge 110e is smaller than the curvature of the end-surface-side second ridge 110f. The curvature of the end-surface-side third ridge 110g is smaller than the curvature of the end-surface-side fourth ridge 110h. The curvature of the end-surface-side first ridge 110e and the curvature of the end-surface-side third ridge 110g are substantially the same. The curvature of the end-surface-side second ridge 110f and the curvature of the end-surface-side fourth ridge 110h are substantially the same.

The curvature of the first ridge 110a as seen in the cross section P of the base body 110 is smaller than the curvature of the end-surface-side first ridge 110e as seen in the cross section Q of the base body 110. The curvature of the second ridge 110b as seen in the cross section P of the base body 110 is smaller than the curvature of the end-surface-side second ridge 110f as seen in the cross section Q of the base body 110.

The base body 110 has a plurality of corners. The corner is defined by an intersection among three surfaces of the base body 110. That is, the plurality of corners are each defined by an intersection among adjacent three surfaces of the first principal surface 111, the second principal surface 112, the first side surface 113, the second side surface 114, the first end surface 115, and the second end surface 116. Each of the plurality of corners may be rounded.

The dimension of the base body 110 in the width direction W may be 0.05 mm or more and 2.5 mm or less. The dimension of the base body 110 in the lamination direction T may be 0.05 mm or more and 2.5 mm or less. The dimension of the base body 110 in the longitudinal direction L may be 0.1 mm or more and 3.2 mm or less. Note that the above dimensional values do not include tolerances.

The first outer electrode 120 is provided on the first end surface 115. Specifically, the first outer electrode 120 is formed over the entire first end surface 115 so as to extend from the first end surface 115 onto the first principal surface 111, the second principal surface 112, the first side surface 113, and the second side surface 114.

The second outer electrode 130 is provided on the second end surface 116. Specifically, the second outer electrode 130 is formed over the entire second end surface 116 so as to extend from the second end surface 116 onto the first principal surface 111, the second principal surface 112, the first side surface 113, and the second side surface 114.

The first outer electrode 120 and the second outer electrode 130 include, for example, an underlying electrode layer and a plating layer disposed on the underlying electrode layer. The underlying electrode layer includes at least one of layers such as a baked electrode layer, a resin electrode layer, and a thin-film electrode layer. Note that, in FIG. 2 and the like, the underlying electrode layer and the plating layer are collectively illustrated as a single layer.

The baked electrode layer is a layer containing glass and metal, and may be composed of a single layer or a plurality of layers. The baked electrode layer is composed of, for example, one kind of metal selected from the group consisting of Ni, Cu, Ag, Pd, and Au, or an alloy containing such a metal and, for example, contains an alloy containing Ag and Pd or the like.

The baked electrode layer can be formed by applying a conductive paste containing glass and metal onto the base body 110, followed by baking. The baking may be performed simultaneously with firing of the base body 110, or after the firing of the base body 110.

The resin electrode layer may be formed as, for example, a layer containing conductive particles and a thermosetting resin. In the case where the resin electrode layer is to be formed, the resin electrode layer may be formed directly on the base body 110 without forming the baked electrode layer. The resin electrode layer may be composed of a single layer or a plurality of layers.

The thin-film electrode layer is, for example, a layer of 1 μm or less composed of metal particles deposited, and may be formed by a known thin-film forming method such as a sputtering method or a vapor deposition method.

The plating layer, which is disposed on the underlying electrode layer, is composed of, for example, one kind of metal selected from the group consisting of Ni, Cu, Ag, Pd, and Au, or an alloy containing such a metal and, for example, contains an alloy containing Ag and Pd or the like. The plating layer may be composed of a single layer or a plurality of layers. However, the plating layer may have a two-layer structure in which a Sn plating layer is formed on a Ni plating layer. The Ni plating layer serves to prevent the underlying electrode layer from being corroded by solder at the time of mounting the multilayer ceramic capacitor 100. The Sn plating layer serves to improve wettability of solder at the time of mounting the multilayer ceramic capacitor 100.

The base body 110 includes a plurality of inner electrode layers 118 and a plurality of dielectric layers laminated alternately along the lamination direction T.

The plurality of dielectric layers include a first outer layer 119a having the first principal surface 111, a second outer layer 119b having the second principal surface 112, and inner layers 119c disposed between inner electrode layers 118 neighboring one another in the lamination direction T. The number of dielectric layers may be 100 or more and 1000 or less. The thickness dimension of the first outer layer 119a and the thickness dimension of the second outer layer 119b may be 20 μm or more and 120 μm or less. The thickness dimension of each of the inner layers 119c may be 0.4 μm or more and 6.2 μm or less.

For each of the plurality of dielectric layers, for example, a dielectric ceramic containing a component such as BaTiO₃, CaTiO₃, SrTiO₃, or CaZrO₃ may be employed as a ceramic material. Alternatively, a material further containing a secondary component such as a Mn compound, an Fe compound, a Cr compound, a Co compound, or a Ni compound in addition to the above-described principal component may be employed.

In the present embodiment, the first outer layer 119a, the second outer layer 119b, and the inner layers 119c are of substantially the same ceramics material system. The expression “substantially the same ceramics material system” refers to substantially the same compositional ratio of raw ceramics materials, and the range of variation in ceramics composition due to variation in compositional ratio or manufacturing process falls within substantially the same ceramics material system.

The plurality of inner electrode layers 118 include first layers 118a and second layers 118b. In the inner portion of the base body 110, the first layers 118a and the second layers 118b are laminated alternately along the lamination direction T. Each of the plurality of first layers 118a and the plurality of second layers 118b is disposed parallel to the longitudinal direction L and the width direction W. The inner layer 119c is disposed between the first layer 118a and the second layer 118b neighboring one another in the lamination direction T. That is, the first layer 118a and the second layer 118b neighboring one another in the lamination direction T are opposed to each other with the inner layer 119c interposed therebetween.

The first layers 118a are extended to the first end surface 115. The first end surface 115 is covered with the first outer electrode 120. The first outer electrode 120 is electrically connected to the first layers 118a. The second layers 118b are extended to the second end surface 116. The second end surface 116 is covered with the second outer electrode 130. The second outer electrode 130 is electrically connected to the second layers 118b.

Note that, although the first layers 118a and the second layers 118b are both composed of seven layers in the example illustrated in FIGS. 2 and 3, the number of first layers 118a or second layers 118b is not limited to 7. The total number of first layers 118a and second layers 118b may be 100 or more and 1000 or less. The thickness dimension of each of the first layers 118a and the second layers 118b may be 0.4 μm or more and 1.2 μm or less.

The thickness dimension of the inner electrode layer 118 can be calculated by the following method. First, the base body 110 is subjected to a polishing process so that a W-T cross section in the central portion in the longitudinal direction L of the base body 110 is exposed. Next, five virtual lines are set which are composed of: a center line passing through the center in the width direction W and extending along the lamination direction T; two virtual lines disposed parallel to the center line to be away from the center line at equal spaces toward the first side surface 113; and two virtual lines disposed parallel to the center line to be away from the center line at equal spaces toward the second side surface 114. Next, the thickness dimension of the inner electrode layer 118 is measured on the respective lines. Next, an average value of the five measurement values obtained as described above is calculated. The average value calculated in this way is taken as the thickness dimension of the inner electrode layer 118. Note that an interval between neighboring ones of the lines may be 5 μm or more.

In the case where an average thickness dimension of the entire plurality of inner electrode layers 118 is to be calculated, the following method can be employed. The above-described measurement of the thickness dimension of the inner electrode layer 118 on each of the five virtual lines is performed for the following three positions: a position on the side of the first principal surface 111 in the lamination direction T; a position on the side of the second principal surface 112 in the lamination direction T; and a position at the central portion in the lamination direction T, so that the above-described average value is calculated for each of the three positions. Subsequently, an average value of the three average values is calculated. The average value calculated in this way is taken as the average thickness dimension of the entire plurality of inner electrode layers 118.

Each of the measurement operations described above can be performed by observing the cross section with a scanning electron microscope or the like. Note that the thickness dimension of the dielectric layer can also be measured in the same manner as described above, although the description thereof is omitted here.

The first layer 118a has a first opposing portion 118a1 and a first extended portion 118a2. The first opposing portion 118a1 opposes the second layer 118b that neighbors the first opposing portion 118a1 in the lamination direction T. The first extended portion 118a2 connects the first opposing portion 118a1 and the first outer electrode 120. The first extended portion 118a2 is extended onto the first end surface 115. The first opposing portion 118a1 and the first extended portion 118a2 are integrally formed.

The second layer 118b has a second opposing portion 118b1 and a second extended portion 118b2. The second opposing portion 118b1 opposes the first layer 118a that neighbors the second opposing portion 118b1 in the lamination direction T. The second extended portion 118b2 connects the second opposing portion 118b1 and the second outer electrode 130. The second extended portion 118b2 is extended onto the second end surface 116. The second opposing portion 118b1 and the second extended portion 118b2 are integrally formed.

Each of the first layer 118a and the second layer 118b contains one kind of metal selected from the group consisting of Ni, Cu, Ag, Pd, and Au, or an alloy containing such a metal. Examples of such an alloy include an alloy containing Ag and Pd and the like. In the present embodiment, each of the first layer 118a and the second layer 118b contains Ni as a principal component. Each of the first layer 118a and the second layer 118b may further contain dielectric particles of the same compositional system as the ceramic contained in the dielectric layers. In addition, each of the first layer 118a and the second layer 118b may contain Sn in an interface between the first or second layer and the dielectric layer.

The base body 110 includes an inner layer portion C. The inner layer portion C has an electrostatic capacity due to the first opposing portions 118a1 of the first layers 118a and the second opposing portions 118b1 of the second layers 118b laminated in the lamination direction T.

In the present embodiment, the dimension of the first outer layer 119a in the lamination direction T is set to be substantially the same as the dimension of the second outer layer 119b in the lamination direction T. Accordingly, the inner layer portion C sandwiched by the first outer layer 119a and the second outer layer 119b in the lamination direction T is positioned in the center in the lamination direction T of the base body 110. Note that the inner layer portion C may be biased toward the side of the first principal surface 111 in the lamination direction T, or toward the side of the second principal surface 112 in the lamination direction T.

Here, in the cross section of the base body 110 taken in the lamination direction T and the width direction W in the central portion in the longitudinal direction L, the plurality of inner electrode layers 118 include a plurality of first inner electrode layers 118A, a plurality of second inner electrode layers 118B, and a plurality of third inner electrode layers 118C, as illustrated in FIGS. 3 and 6.

The plurality of first inner electrode layers 118A are positioned on the side of the first principal surface 111 in the lamination direction T. The plurality of second inner electrode layers 118B are positioned on the side nearer to the second principal surface 112 in the lamination direction T than the plurality of first inner electrode layers 118A. The plurality of third inner electrode layers 118C are positioned between the plurality of first inner electrode layers 118A and the plurality of second inner electrode layers 118B in the lamination direction T. In other words, the plurality of first inner electrode layers 118A, the plurality of third inner electrode layers 118C, and the plurality of second inner electrode layers 118B are positioned in this order from the side of the first principal surface 111 to the side of the second principal surface 112 in the lamination direction T.

In the above-mentioned cross section of the base body 110, opposite end portions 151A in the width direction W of the plurality of first inner electrode layers 118A are curved toward the second principal surface 112. The curvature of each of the opposite end portions 151A is set to, for example, 0.004 (1/μm) or more and 0.02 (1/μm) or less.

In the above-mentioned cross section of the base body 110, opposite end portions 151B in the width direction W of the plurality of second inner electrode layers 118B are curved toward the first principal surface 111. The curvature of each of the opposite end portions 151B is set to, for example, 0.004 (1/μm) or more and 0.02 (1/μm) or less.

In the above-mentioned cross section of the base body 110, the plurality of third inner electrode layers 118C extend substantially linearly along the width direction W. Here, the phrase “extend substantially linearly along the width direction W” means that the curvature of each of the opposite end portions in the width direction W of the third inner electrode layers 118C is 0.001 (1/μm) or less. The third inner electrode layers 118C may function as a stress-neutralization zone (buffer region) positioned between the first inner electrode layers 118A and the second inner electrode layers 118B. This buffer region balances the opposing curvatures and mechanical stresses of the surrounding layer sets, reducing the risk of internal short-circuiting.

As illustrated in FIG. 2, in the cross section of the base body 110 taken in the lamination direction T and the longitudinal direction L in the central portion in the width direction W, an end portion of the opposing portion of each of the plurality of first inner electrode layers 118A is curved toward the second principal surface 112 on the opposite side from the extended portion in the longitudinal direction L. The curvature of the above-mentioned end portions of the first inner electrode layers 118A is set to, for example, 0.004 (1/μm) or more and 0.02 (1/μm) or less.

In the above-mentioned cross section of the base body 110, an end portion of the opposing portion of each of the plurality of second inner electrode layers 118B is curved toward the first principal surface 111 on the opposite side from the extended portion in the longitudinal direction L. The curvature of the above-mentioned end portions of the second inner electrode layers 118B is set to, for example, 0.004 (1/μm) or more and 0.02 (1/μm) or less.

The number of second inner electrode layers 118B is greater than the number of first inner electrode layers 118A. The number of second inner electrode layers 118B may be 1.5 times or more and 9 times or less the number of first inner electrode layers 118A. The number of third inner electrode layers 118C may be smaller than the number of first inner electrode layers 118A. In the present embodiment, the plurality of inner electrode layers 118 have four first inner electrode layers 118A, seven second inner electrode layers 118B, and three third inner electrode layers 118C.

The curvature of the opposite end portions 151A of the plurality of first inner electrode layers 118A may increase from the side of the second principal surface 112 toward the side of the first principal surface 111. The curvature of the opposite end portions 151B of the plurality of second inner electrode layers 118B may increase from the side of the first principal surface 111 toward the side of the second principal surface 112. Note that not all of the plurality of opposite end portions 151A necessarily need to satisfy the requirement that the curvature should “increases from the side of the second principal surface 112 toward the side of the first principal surface 111”, and the above requirement may be satisfied when the plurality of opposite end portions 151A are observed as a whole. The same holds true for the plurality of opposite end portions 151B.

In the cross section of the base body 110 taken in the lamination direction T and the width direction W in the central portion in the longitudinal direction L, the curvature of the opposite end portions 151A of the first inner electrode layer 118A nearest to the first principal surface 111 among the plurality of first inner electrode layers 118A is greater than the curvature of the opposite end portions 151B of the second inner electrode layer 118B nearest to the second principal surface 112 among the plurality of second inner electrode layers 118B.

The opposite end portions of the respective inner electrode layers which are curved as described above can be confirmed by, for example, subjecting the base body 110 to a polishing process so that the W-T cross section of the base body 110 in the central portion in the longitudinal direction L is exposed and then observing the cross section with an optical microscope or the like.

### B. Method of Producing Multilayer Ceramic Capacitor

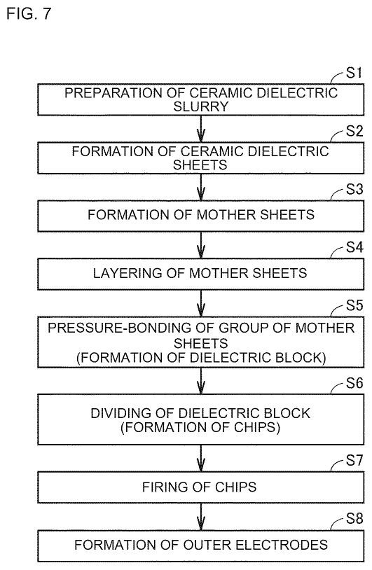

FIG. 7 is a flowchart showing a method of producing the multilayer ceramic capacitor according to the embodiment. Next, the method of producing the multilayer ceramic capacitor 100 according to the present embodiment will be described with reference to FIG. 7.

First, as shown in FIG. 7, ceramic dielectric slurry is prepared (step S1). Specifically, ceramic dielectric powder, a powder additive, a binder resin, a dissolution solution, and the like are dispersed and mixed. Through this operation, the ceramic dielectric slurry is prepared.

The ceramic dielectric powder is composed of dielectric particles having a perovskite structure, such as BaTiO₃, CaTiO₃, SrTiO₃, CaZrO₃, or CaHfO₃. The powder additive is composed of, for example, at least one of a Si compound, a Mg compound, a Mn compound, an Fe compound, a Cr compound, a Ni compound, and a Co compound. Examples of the binder resin include polyurethane resins, urea resins, melamine resins, epoxy resins, vinyl acetate resins, acrylic resin-based materials, and water-based polymers such as polyvinyl alcohol (PVA) and polyvinyl butyral (PVB). These may be used alone or in combination of two or more as a mixture. The ceramic dielectric slurry may be solvent-based or water-based. When the ceramic dielectric slurry is a water-based paint, a water-soluble binder, a dispersant, and the like are mixed with a dielectric raw material dissolved in water, thereby preparing the ceramic dielectric slurry.

Next, ceramic dielectric sheets are formed (step S2). Specifically, the ceramic dielectric slurry is formed into a sheet-like shape with a die coater, a gravure coater, a micro-gravure coater, or the like on a carrier film, followed by drying. Through this operation, the ceramic dielectric sheets are formed.

Next, mother sheets are formed (step S3). Specifically, a conductive paste is applied onto each of the ceramic dielectric sheets so as to have a predetermined pattern. Through this operation, the mother sheets having predetermined inner electrode patterns on the ceramic dielectric sheets are formed. The conductive paste contains Ni powder, a solvent, a dispersant, a binder, and the like, and is prepared so as to have a predetermined viscosity. Examples of the binder include PVA, PVB, or the like. Examples of the method of applying the conductive paste include a screen printing method, an inkjet method, a gravure printing method, and the like. Note that, as the mother sheets, not only the mother sheets having the inner electrode patterns but also ceramic dielectric sheets not subjected to the above-described step S3 are also prepared.

Next, the plurality of mother sheets are layered on one another (step S4). This layering process is performed with a layering apparatus mainly having a head part and a stage part.

The head part has a planar holding surface for holding the mother sheet. The head part is configured to move the mother sheet by moving in a predetermined direction in a state where the mother sheet is kept on the holding surface. The head part may hold the mother sheet by any method without any limitation, and may be configured to hold the mother sheet by, for example, an absorbing force or an adhesive force. The stage part has a flat-plate shape. The plurality of mother sheets are sequentially layered on one another on the stage part by means of the head part.

First, a predetermined number of mother sheets each composed of the ceramic dielectric sheet alone without any inner electrode pattern are layered on the stage part. On top of them, a predetermined number of mother sheets each having the inner electrode pattern are layered. On top of them, a predetermined number of mother sheets each composed of the ceramic dielectric sheet alone without any inner electrode pattern are further layered. Through this operation, a group of mother sheets is formed.

In the course of layering the predetermined number of mother sheets having the inner electrode patterns, the opposite end portions in the width direction W and the end portions of the opposing portions on the opposite side from the extended portions in the longitudinal direction L of the inner electrode patterns of the mother sheets having been already layered curve upward in the lamination direction T as the layering step proceeds. This is because a downward pressure from the mother sheets being layered on the mother sheets concerned is cumulatively applied onto the mother sheets concerned in the state where the mother sheets positioned under the mother sheets concerned have suitably low rigidity. The inner electrode patterns which curve as described above correspond to the above-described second inner electrode layers 118B. Here, among the inner electrode patterns corresponding to the second inner electrode layers 118B, the curvature of the opposite end portions of the inner electrode pattern on the lower side is greater than the curvature of the opposite end portions of the inner electrode pattern on the upper side. In other words, the curvature becomes smaller from earlier to later stages in the layering order.

As described above, the opposite end portions in the width direction W of the inner electrode patterns of the mother sheets curve upward in the lamination direction T in the earlier stage of the step of layering the mother sheets having the inner electrode patterns. However, as the layering step further proceeds, the inner electrode patterns of the mother sheets being layered tend to extend substantially linearly along the width direction W without curving as described above. This is because the pressure-bonding of the mother sheets positioned under the mother sheet concerned increases the rigidity of the mother sheets positioned under the mother sheet concerned to a suitable extent. The inner electrode patterns substantially linearly extending along the width direction W as described above correspond to the above-described third inner electrode layers 118C.

As the step of layering the mother sheets having the inner electrode patterns further proceeds, the opposite end portions in the width direction W and the end portions of the opposing portions on the opposite side from the extended portions in the longitudinal direction L of the inner electrode patterns of the mother sheets being layered curve downward in the lamination direction T in a sagging fashion. The inner electrode patterns which curve as described above correspond to the above-described first inner electrode layers 118A. Here, among the inner electrode patterns corresponding to the first inner electrode layers 118A, the curvature of the opposite end portions of the inner electrode pattern on the upper side is greater than the curvature of the opposite end portions of the inner electrode pattern on the lower side. In other words, the curvature becomes greater from earlier to later stages in the layering order. This increase in curvature is a resultant property of the cumulative layering pressure applied during the layering of the mother sheets in Step S4. By managing this resultant pressure, the device achieves a specific structural gradient that optimizes mechanical integrity.

Since the opposite end portions of the inner electrode patterns curve downward in the lamination direction T as described above in the final stage of the step of layering the mother sheets having the inner electrode patterns, the mother sheets are more firmly bonded to each other due to the anchoring effect. This effectively reduces the occurrence of delamination between the mother sheets. In particular, the downward curvature of the first inner electrode layers 118A creates an anchoring effect. This anchoring effect is achieved by increasing the interfacial bonding area between the mother sheets during the final layering stage. This increased bonding area provides a mechanical interlock that effectively reduces the occurrence of delamination during the subsequent firing process.

Here, in the present embodiment, the pressure of the head part applied toward the stage part while the mother sheets are placed on the stage part and/or the elastic modulus of the ceramic dielectric sheets and the inner electrode patterns which constitute the mother sheets are adjusted as appropriate so that the number of inner electrode patterns corresponding to the second inner electrode layers 118B is set to be greater than the number of inner electrode patterns corresponding to the first inner electrode layers 118A.

Next, the group of mother sheets is pressure-bonded so that a dielectric block is formed (step S5). Specifically, the group of mother sheets is pressure-bonded in the lamination direction by isostatic press or rigid-body press. Through this operation, the dielectric block is formed. At this time, the ceramic dielectric sheets are pressed at a predetermined temperature so that the ceramic dielectric sheets closely adhere to each other. In addition, ceramic dielectric sheets are placed so as to provide a predetermined thickness on the outermost layers in the lamination direction, followed by pressing. This allows the dielectric sheets having the inner electrode patterns to be protected.

Next, the dielectric block is divided so that chips are formed (step S6). Specifically, the dielectric block is divided in a matrix pattern by press-cutting, dicing, or laser cutting and thereby individualized into a plurality of chips. The dielectric block may be divided in a heated and softened state. When dividing the dielectric block, the corners and ridges of the chips may be rounded by barrel polishing or the like.

Next, the chips are fired (step S7). Specifically, heating the chips causes the dielectric material and the conductive material contained in the chips to be fired, thereby forming the base body 110. The firing temperature is set to, for example, 900° C. or more and 1300° C. or less. The firing temperature is appropriately set in accordance with the dielectric material and the conductive material.

Next, the outer electrodes are formed (step S8). Specifically, a paste containing, for example, Ni as a principal component and a material, which is a dielectric material, is applied onto both the end surfaces of the base body 110. After the application of the paste, the base body 110 and the underlying electrode layers are co-fired. After the firing, the underlying electrode layers are plated. Examples of plating methods include electrolytic plating.

In the multilayer ceramic capacitor 100 produced as described above, when the base body 110 is seen in the cross section P (see FIG. 3), the curvature of the first ridge 110a is smaller than the curvature of the second ridge 110b. This relationship allows determination of which principal surface the layering was started from in the step of layering the mother sheets having the inner electrode patterns of the multilayer ceramic capacitor 100. In addition, when the base body 110 is seen in the cross section Q (see FIG. 2), the curvature of the end-surface-side first ridge 110e is smaller than the curvature of the end-surface-side second ridge 110f. This relationship also allows determination of which principal surface the layering was started from in the step of layering the mother sheets having the inner electrode patterns of the multilayer ceramic capacitor 100.

### C. Section Conclusion

As described above, according to the multilayer ceramic capacitor 100 which is produced through the processes including the step of laminating the mother sheets having the inner electrode patterns, the plurality of first inner electrode layers 118A having the opposite end portions 151A which are curved toward the second principal surface 112 are disposed on the side of the first principal surface 111, and the plurality of second inner electrode layers 118B having the opposite end portions 151B which are curved toward the first principal surface 111 are disposed on the side of the second principal surface 112. In addition, the curvature of the opposite end portions 151A of the plurality of first inner electrode layers 118A increases from the side of the second principal surface 112 toward the side of the first principal surface 111.

Accordingly, in the case where the number of first inner electrode layers 118A is increased to a substantial extent, the curvature of the opposite end portions 151A of the first inner electrode layers 118A disposed on the side of the first principal surface 111 is increased as well, resulting in an increased risk of structural defects caused by contact between the inner electrodes neighboring one another in the lamination direction T.

In this regard, according to the present embodiment, the multilayer ceramic capacitor 100 is configured such that the number of second inner electrode layers 118B is greater than the number of first inner electrode layers 118A as described above. In other words, the number of first inner electrode layers 118A is limited to smaller than the number of second inner electrode layers 118B.

This configuration leads to a reduction in the occurrence of the above-described structural defects in the multilayer ceramic capacitor 100.

In addition, according to the present embodiment, the curvature of the opposite end portions 151A of the first inner electrode layer 118A nearest to the first principal surface 111 among the plurality of first inner electrode layers 118A is greater than the curvature of the opposite end portions 151B of the second inner electrode layer 118B nearest to the second principal surface 112 among the plurality of second inner electrode layers 118B as described above, in the cross section of the base body taken in the lamination direction T and the width direction W in the central portion in the longitudinal direction L (see FIGS. 3 and 6). In this manner, setting the curvature of the opposite end portions 151A nearest to the first principal surface 111 to be suitably large within a range in which structural defects do not occur leads to an effective reduction in the occurrence of delamination between the mother sheets having the inner electrode patterns in the course of production processes.

### Other Configurations and the Like

The shapes, configurations, sizes, quantities, materials, and other features of the respective components shown in the foregoing embodiments of the present disclosure may be variously modified without departing from the spirit of the present invention.

The characteristic configurations shown in the foregoing embodiments of the present disclosure may, of course, be combined with one another without departing from the spirit of the present disclosure.

Thus, the embodiments disclosed above are merely illustrative and not restrictive in all respects. The technical scope of the present invention is defined by the claims, and encompasses all modifications within the meaning and scope equivalent to the claims.

What is claimed is:

1. A multilayer ceramic capacitor comprising:
a base body including a plurality of dielectric layers and a plurality of inner electrode layers laminated in a lamination direction, the base body having a first principal surface and a second principal surface disposed opposite to each other in the lamination direction; and
outer electrodes provided to the base body and connected to the plurality of inner electrode layers, wherein
in a cross section of the base body taken in the lamination direction and a width direction,
the plurality of inner electrode layers have a first set of inner electrode layers having end portions curved toward the second principal surface and a second set of inner electrode layers having end portions curved toward the first principal surface,
the second set of second inner electrode layers is disposed closer to the second principal surface than the first set of inner electrode layers, and
a number of inner electrode layers of the second set is greater than a number inner electrode layers of the first set.

2. The multilayer ceramic capacitor according to claim 1, wherein
the plurality of dielectric layers each have a thickness dimension of between 0.4 μm to 6.2 μm, inclusive.

3. The multilayer ceramic capacitor according to claim 1, wherein
in the cross section of the base body, a curvature of the end portions of a layer of the first set of inner electrode layers nearest to the first principal surface is greater than a curvature of the end portions of a layer of the second set of inner electrode layers nearest to the second principal surface.

4. The multilayer ceramic capacitor according to claim 1, wherein
the plurality of inner electrode layers further include a third set of inner electrode layers positioned between the first set of inner electrode layers and the second set of inner electrode layers in the lamination direction.

5. The multilayer ceramic capacitor according to claim 4, wherein layers of the third set of inner electrode layers extend substantially linearly along the width direction.

6. The multilayer ceramic capacitor according to claim 4, wherein
a number of inner electrode layers of the third set is less than the number inner electrode layers of the first set.

7. The multilayer ceramic capacitor according to claim 4, wherein a curvature of the layers of the third set of inner electrode layers is 0.001 (1/μm) or less.

8. The multilayer ceramic capacitor according to claim 1, wherein the number of layers in the second set of inner electrode layers is between 1.5 times to 9 times, inclusive, the number of layers in the first set of inner electrode layers.

9. The multilayer ceramic capacitor according to claim 1, wherein a curvature of the first set of inner electrode layers increases from a side of the second principal surface toward a side of the first principal surface.

10. The multilayer ceramic capacitor according to claim 1, wherein a curvature of the second set of inner electrode layers increases from a side of the first principal surface toward a side of the second principal surface.

11. The multilayer ceramic capacitor according to claim 1, wherein the base body has
a first side surface and a second side surface disposed opposite to each other in a width direction orthogonal to the lamination direction,
a first end surface and a second end surface disposed opposite to each other in a longitudinal direction orthogonal to the lamination direction and the width direction,
a first ridge defined by an intersection between the first side surface and the first principal surface,
a second ridge defined by an intersection between the first side surface and the second principal surface, and
in the cross section of the base body, a curvature of the first ridge is smaller than a curvature of the second ridge.

12. A multilayer ceramic capacitor comprising:
a base body including inner electrode layers laminated between dielectric layers; and
outer electrodes provided to the base body and connected to the inner electrode layers, wherein
the inner electrode layers include a first layer group having a curvature in a first direction and a second layer group having a curvature in a second direction opposite the first direction, and
a first curvature of an inner electrode layer in the first layer group positioned closest to a first surface of the base body is greater than a second curvature of an inner electrode layer in the second layer group positioned closest to a second surface of the base body.

13. The multilayer ceramic capacitor according to claim 12, wherein the first curvature and the second curvature are each between 0.004 (1/μm) and 0.02 (1/μm), inclusive.

14. The multilayer ceramic capacitor according to claim 12, wherein the inner electrode layers further include a third layer group positioned between the first layer group and the second layer group, layers in the third layer group extending substantially linearly.

15. The multilayer ceramic capacitor according to claim 12, wherein the base body has a first ridge at the first surface and a second ridge at the second surface, and a curvature of the first ridge is smaller than a curvature of the second ridge.

16. The multilayer ceramic capacitor according to claim 12, wherein each inner electrode layer has a thickness dimension between 0.4 μm and 1.2 μm, inclusive.

17. A multilayer ceramic capacitor comprising:
a base body including inner electrode layers laminated between dielectric layers;
the inner electrode layers including, in order from a first principal surface to a second principal surface:
(i) a first group of layers curved toward the second principal surface;
(ii) a second group of layers extending substantially linearly; and
(iii) a third group of layers curved toward the first principal surface;
wherein a number of layers in the third group is greater than a number of layers in the first group.

18. The multilayer ceramic capacitor according to claim 17, wherein a number of layers in the second group is less than the number of layers in the first group.
